(19) United States
(12) Patent Application Publication
(10) Pub. No.: US 2014/0062243 A1
(43) Pub. Date: Mar. 6, 2014

(54) INTERNAL ROTOR MOTOR

(71) Applicants: Dominik Falk, Moenchweiler (DE); Arnold Schulde, VS-Schwenningen (DE); Mojtaba Moini, Tuebingen (DE)

(72) Inventors: Dominik Falk, Moenchweiler (DE); Arnold Schulde, VS-Schwenningen (DE); Mojtaba Moini, Tuebingen (DE)

(73) Assignee: EBM-PAPST ST. GEORGEN GmbH & Co. KG, ST. GEORGEN (DE)

(21) Appl. No.: 14/118,238

(22) PCT Filed: Jul. 12, 2012
(86) PCT No.: PCT/EP2012/002930

§ 371 Date: Nov. 17, 2013

(30) Foreign Application Priority Data
Jul. 22, 2011 (DE) 10 2011 108 677.7

(51) Int. Cl. H02K 1/22; H02K 1/27

(52) U.S. Cl. CPC H02K 1/22; H02K 1/27
USPC 310/156.08; 310/261.1

(57) ABSTRACT

An internal rotor motor, in particular an electronically commutated internal rotor motor, has a multi-pole stator (28) and a rotor lamination stack (37; 52, 54, 56) mounted rotatably relative to said stator; furthermore a central bore is provided in the rotor lamination stack, the rotor lamination stack comprising individual laminations (41) whose respective central openings (47) comprise radially inwardly projecting first portions or tabs (50) into which a rotor shaft (18) is press-fitted, and said central openings (47) comprise, in angular sectors between the first portions (50), second portions (51) that, in the assembled state, are spaced away from the outside of the shaft (18), at least some (axially central) ones of the individual laminations (41) of the rotor lamination stack (52) being arranged with an angular offset from one another.

### CROSS-REFERENCE

This application is a section 371 of PCT/EP2012/002930, filed 2012-07-12, and further claims priority from German application DE 10 2011 108 677-A, filed 2011 Jul. 22, the entire contents of which are hereby incorporated by reference.

### FIELD OF THE INVENTION

The invention relates to an internal rotor motor, and in particular to an electronically commutated internal rotor motor.

### BACKGROUND

A motor of this kind has a rotor, usually in the form of a rotor lamination stack, into which permanent magnets are embedded. This rotor is connected to a shaft so that a torque can be transferred in the shaft/rotor system.

If the shaft is press-fitted directly into the rotor, excessively large press-fit forces can occur during manufacture, which on the one hand can damage or destroy the rotor and can also result in damage to the shaft, since the latter can be warped by an excessive buckling load and thus result in rejection.

DE 10 2006 037 804 A1 of inventors Hartkorn, Kienzler & Mauch, assigned to EBM-PAPST, discloses an internal rotor motor having a hollow shaft on whose outer surface are provided notches, for connection to the rotor stack. These notches reduce the surface pressure on the shaft, and lower press-fit forces thus occur in the context of installation of the shaft, which is also referred to as a “joining process” or “joining operation.” As a result of the reduced surface pressure, however, chips can be detached from the shaft and can remain on the rotor stack. Cold welding can occur in this context between the rotor stack and shaft. The hardness pairing of the shaft, on the one hand, and rotor stack, on the other hand, also plays a role here, and this pairing can have a very negative effect on press-fit forces.

It is not possible to specify accurately the hardness pairing between the rotor, on the one hand, and shaft, on the other hand, by design of the materials, since the hardness values of electrical steels fluctuate widely. Two problems thus exist when a notch connection is used:
1. chips in the connection,
2. a joining operation that is not reliable in terms of process, due to hardness fluctuations of the materials as related to one another.

### SUMMARY OF THE INVENTION

It is therefore an object of the invention to make available a novel internal rotor motor whose structure minimizes such problems.

According to the invention, this object is achieved by an internal rotor motor wherein the rotor stack consists of a plurality of generally annular laminations or plates, each having a central opening whose periphery includes radially inwardly projecting first portions and, spaced circumferentially therefrom, second portions which remain spaced from the rotor shaft. After assembling together the laminations to form the rotor stack, the rotor shaft is joined to the stack by axially press-fitting into a central bore of the rotor lamination stack, and the shaft is held securely by engagement with the first portions or “teeth.” With the new connection between the rotor and shaft, only a very slight risk of chip formation during the joining process therefore exists. The geometry of the rotor lamination stack (tooth geometry) can be optimized so that an ideal press-fit and pressing-out force, and an ideal torque, exist, and the connection substantially does not react to differences in hardness between the rotor lamination stack and shaft, i.e. in contrast to the situation with use of a notch connection. The novel connection has the advantage that no complex additional processes are necessary in the context of manufacture of the shaft, i.e. no production of notches in cut into the shaft. A reproducible force/travel curve exists, and accurate analyses of the connection can be made on the basis of that curve. The connection is thus reliable in terms of process.

### BRIEF FIGURE DESCRIPTION

Further details and advantageous refinements of the invention are evident from the exemplifying embodiments, in no way to be understood as a limitation of the invention, that are described below and depicted in the drawings.

FIG. 1 is a schematic section through an exemplifying internal rotor motor whose rotor is excited by embedded permanent magnets; the section is drawn perpendicular to the rotor shaft,

FIG. 2 is an enlarged depiction of detail II of FIG. 1,

FIG. 3 schematically depicts a rotor lamination and the location of the embedded permanent magnets relative to that rotor lamination,

FIG. 4 is a perspective depiction of the shaft and of the rotor lamination stack before they are axially assembled together,

FIG. 5 is an enlarged depiction of detail V of FIG. 4,

FIG. 6 is an enlarged depiction of detail VI of FIG. 4, and

FIG. 7 is an enlarged depiction of detail VII of FIG. 4.

FIG. 8 and FIG. 9 are enlarged depictions of a three-phase series delta circuit, and

FIGS. 10 and 11 depict a three-phase parallel delta circuit.

### DETAILED DESCRIPTION

In the drawings that follow, identical or identically-functioning parts are labeled with the same reference characters and are in each case described only once. Terms such as “upper,” “lower,” “left,”, and “right” refer to the particular figure of the drawings.

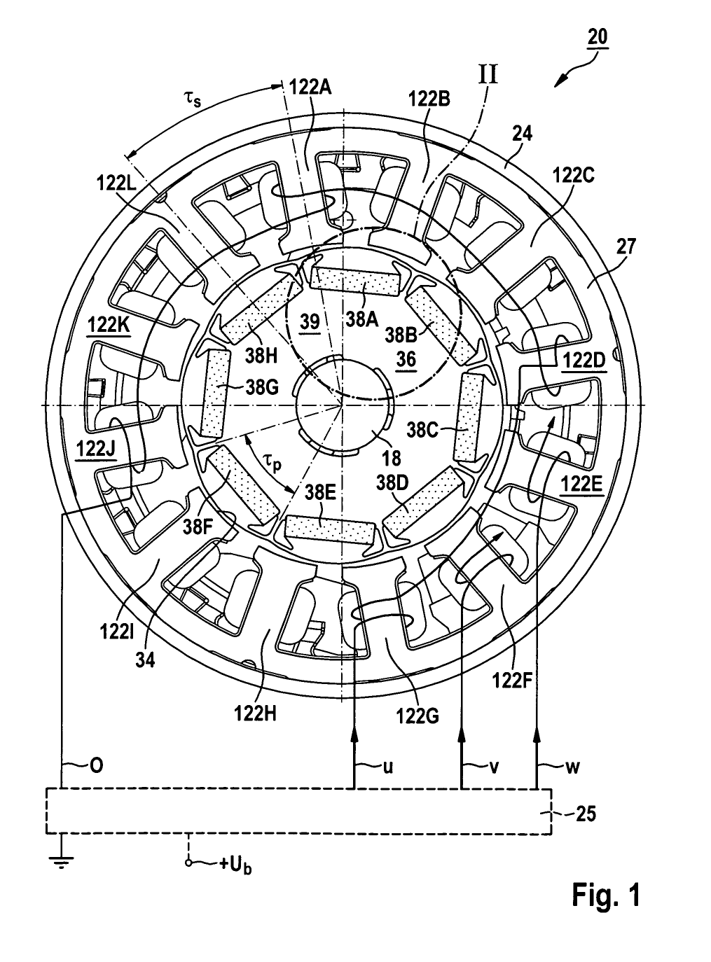

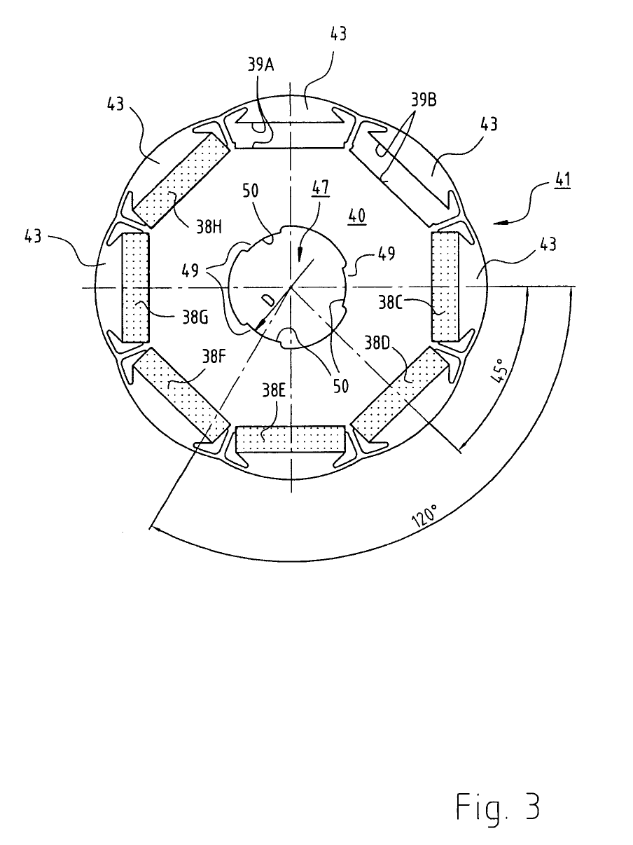

FIG. 1 schematically depicts a cross section, extending perpendicular to a shaft 18, through a three-phase internal rotor motor 20 having a casing-shaped housing 24. Arranged therein is a lamination stack 27 of an external stator 28. The latter has an inner opening 34 in which an eight-pole internal rotor 36, having a lamination stack 37 made up of generally annular rotor laminations 41 (depicted schematically in FIG. 3) and having a total of eight permanent magnets 38A to 38H (see FIGS. 1 to 3), is arranged on shaft 18. A magnetically effective air gap 32 separates stator 28 from rotor 36. A motor of this kind can be referred to in various ways, e.g. as a “permanently excited synchronous internal rotor machine,” or as an “electronically commutated sine-wave motor,” or simply as a “three-phase motor.” It can be supplied with power, for example, from a three-phase grid, or by means of a suitable three-phase inverter 25 that is indicated by way of example in FIG. 1.

In one possible use of a motor 20 according to the present application, it serves to save fuel in a motor vehicle.

When a motor vehicle is driving on an expressway, the steering forces are very low, and steering assistance is then not needed, i.e. motor 20 can be switched off.

When the vehicle needs to be parked, however, steering assistance is desirable. For this purpose, motor 20 for steering assistance must start very quickly and reliably and, especially at extremely low temperatures, said motor 20 must in a short time transfer a very high torque from rotor 36 via shaft 18 to the servo-assistance system (not shown) of the steering system.

For this, the connection between rotor 36 and shaft 18 must be very reliable but, on the other hand, must not cause rotor 36 or shaft 18 to be damaged or destroyed during manufacture. Such a connection also needs to be economical to manufacture.

FIG. 3 shows one of the rotor laminations 41. These individual laminations generally have a thickness of less than 1 mm, for example 0.3 mm. In the present example, they are largely uniform in shape for the entire rotor 36, but are used in different ways (see description below).

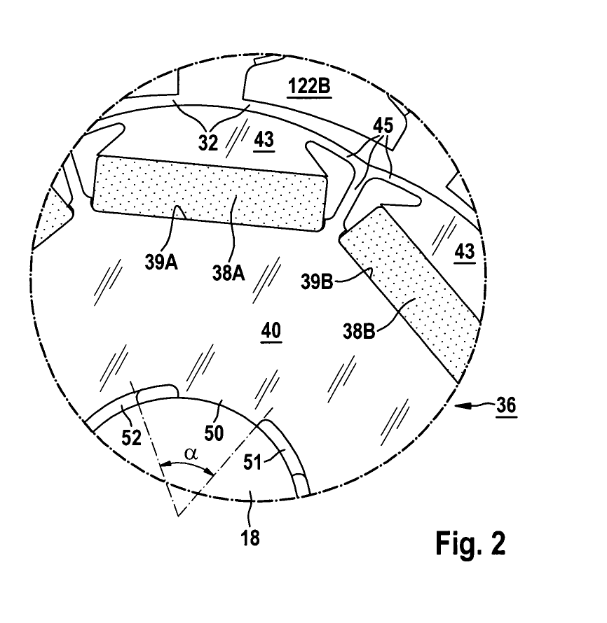

FIG. 3 shows, solely for better comprehension, the location of rotor magnets 38C to 38H in the completed rotor 36. It is expressly noted, however, that the individual rotor laminations 41 only have openings or “pockets” 39 for receiving rotor magnets 38A to 38H, and that the magnets are not inserted until rotor lamination stack 37 is “married” to shaft 18. FIG. 3 shows, by way of example, two empty openings 39A and 39B in which magnets 38A and 38B are secured in the completed rotor 36 (see FIG. 1 and FIG. 2).

Openings 39A, 39B are delimited radially inwardly by magnetic yoke 40, which is mechanically connected in the manner described below to shaft 18 (see FIG. 2). Openings 39A, 39B are delimited on the outside by pole shoes 43, which are mechanically connected in the manner depicted, via thin connections 45 made of rotor lamination (FIG. 2), to yoke 40. These thin connections 45 are saturated by the flux of magnets 38A to 38H 39H, i.e. they have only a mechanical function. Upon manufacture of rotor 36, magnets 38A, 38B are inserted into cavities 39A, 39B, etc. and retained there in suitable fashion, in a manner known to those having ordinary skill in the art.

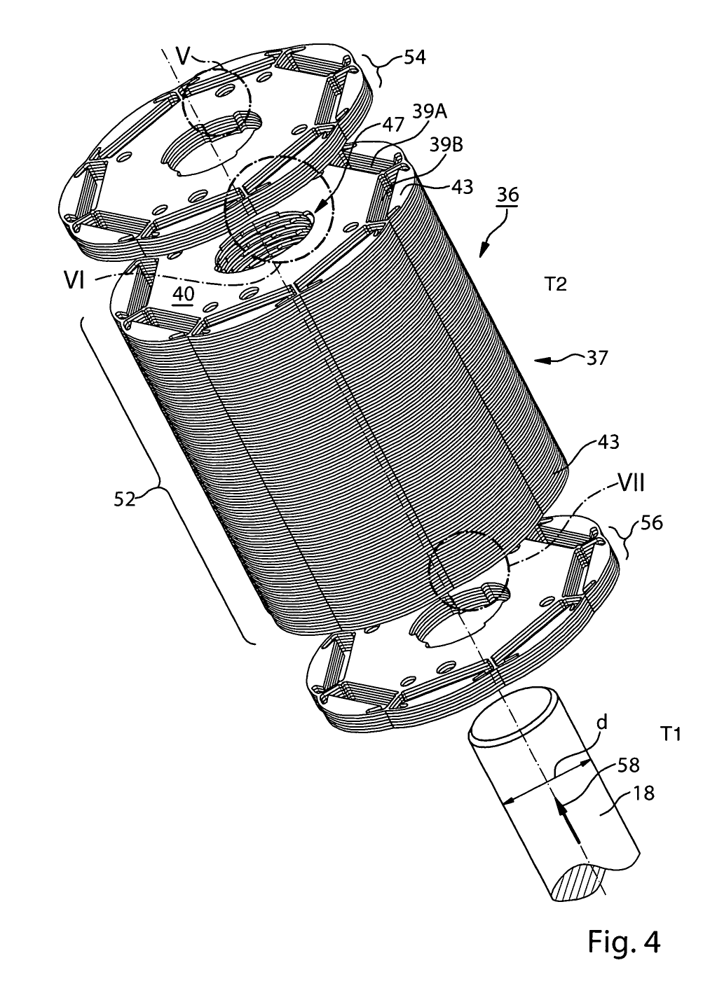

As FIG. 3 shows, each rotor lamination 41 has a central opening 47. The lamination has radially inwardly protruding projections 49 that are bounded internally by circular portions 51 (FIG. 2) whose effective inner diameter D is slightly larger than the outer diameter d (FIGS. 1, 4) of shaft 18, which latter is press-fitted into engagement with projections 49. It is advantageous in this context if projections 49 are provided along a periphery of opening 47 at an identical angular spacing from one another, a quantity of three projections being particularly advantageous. The angular width of projections 49 is usually determined empirically.

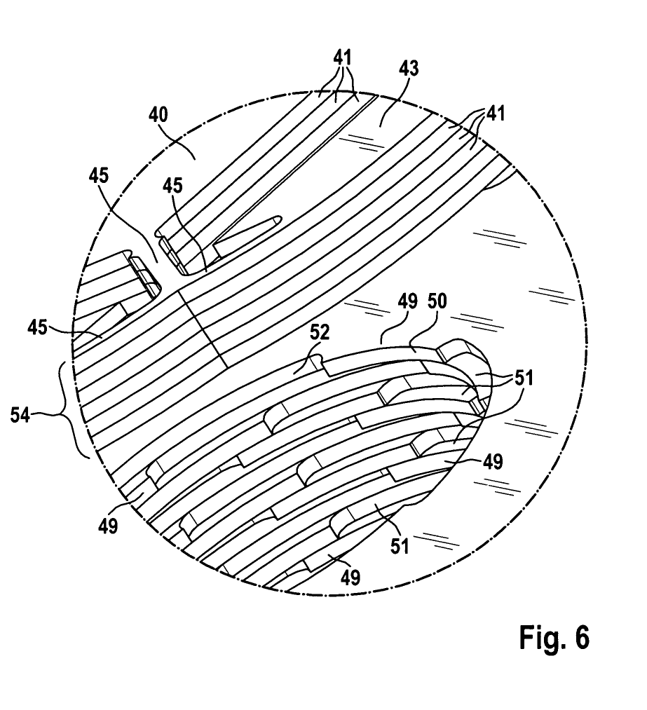

As FIG. 4 and FIG. 6 show, in the central (viewed axially) region 52 of rotor lamination stack 37, successive rotor laminations 41 are angularly offset from each another, by an amount equal to a rotor pole pitch τₚ. Because FIG. 3 shows an eight-pole rotor, therefore: τₚ=360°/8=45°, as indicated in FIG. 3.

For a motor having six rotor poles, the offset τₚ would correspondingly be equal to: τₚ=360°/6=60°.

The offset then produces what is depicted in FIG. 6, i.e. projections 49 are offset from one another by an amount equal to rotor pole pitch τₚ, and located circumferentially between them are sectors or gaps 51 that have no direct engagement against shaft 18, as shown in FIGS. 1 and 2.

FIG. 4 is an exploded view showing rotor lamination stack 37 before shaft 18 is press-fitted. As described, lamination stack 37 has a central region 52 in which rotor laminations 41 are each offset from one another by an amount equal to a rotor pole pitch τₚ, so that shaft 18 (FIG. 1, FIG. 2, FIG. 4) is secured exactly in the middle of central opening 47, and high costs for eliminating center-of-mass imbalances are not incurred.

Arranged at both ends of the central lamination stack region 52 are short lamination stacks 54 (FIG. 4, top) and 56 (FIG. 4, bottom) that in FIG. 4 are each made up, for example, of n+1 laminations 41 that are not offset from one another, n being a natural number. A short stack portion of this kind usually has two to 10 laminations.

These short stacks 54, 56 serve to facilitate the press-fitting of shaft 18. The press-fit insertion direction of shaft 18 is labeled 58 in FIG. 4 and extends along the axis of the rotor, and short stack 56 serves to produce a favorable value for the press-fit force. Short stack 54 likewise serves to produce a favorable pressing-out force, which of course must not be too high, in order that rotor laminations 41 do not become warped.

With the above-described manner of connection between rotor lamination stack 52, 54, 56 and shaft 18, the risk of chip formation is largely eliminated. The tooth geometry of central rotor lamination stack 52 can be optimized so that favorable values for the press-fit force, pressing-out force, and transferrable torque are obtained, and so that the connection does not react to differences in hardness between lamination stacks 52, 54, 56, on the one hand, and shaft 18, on the other hand. In addition, no complex additional processes are required in the context of the manufacture of shaft 18. A reproducible force/travel curve results, and accurate analyses of the connection can be made on the basis of that curve. The connection is reliable in terms of process, and when the excess pressure (i.e. the “over dimension” of shaft 18) is correctly designed, what is obtained, as described, is less variation in the press-fit values, which enables reliable production.

When shaft 18 is press-fitted, the temperature T1 of shaft 18 and the temperature T2 of rotor lamination stack 37 can be the same (T1=T2). Alternatively, however, a different temperature can be selected (T1≠T2), the temperature T1 of shaft 18 preferably being lower than the temperature T2 of rotor lamination stack 37 (T1<T2). As a result of thermal contraction resulting from the lower temperature, shaft 18 accordingly has, relatively and temporarily, a slightly lower (outside) diameter d than it would otherwise have, and rotor lamination 37 has, as a result of the higher relative temperature, a slightly larger (inside) diameter D (see FIG. 3). The friction between shaft 18 and rotor lamination stack 37 when shaft 18 is press-fitted is thereby reduced, thereby facilitating assembly. It will be apparent that, when the stack and shaft reach equal temperatures, the projections 50 will tend to engage against the outside of the shaft 18 with greater force. It is advantageous that in the context of assembly with a temperature difference (T1<T2), the difference between the effective diameter D (FIG. 3) of rotor lamination stack 37 and the effective diameter d (FIG. 4) of shaft 18 can be selected to be slightly greater than in the case of assembly with identical component temperatures. In combination with first portions 50, this makes possible an even better connection with no risk of destroying first portions 50 of lamination stack 37 during press-fitting.

In the context of press-fitting with different temperatures T1, T2, the inside diameter D (defined by first portions 50) of central opening 47 preferably is sufficiently smaller than the outside diameter d of shaft 18 that nondestructive press-fitting of shaft 18 is possible only when the temperature of shaft 18 upon press-fitting is lower than the temperature of the rotor lamination stack. The different temperatures T1, T2 can, however, also be advantageous in cases in which press-fitting at identical temperatures T1, T2 is possible.

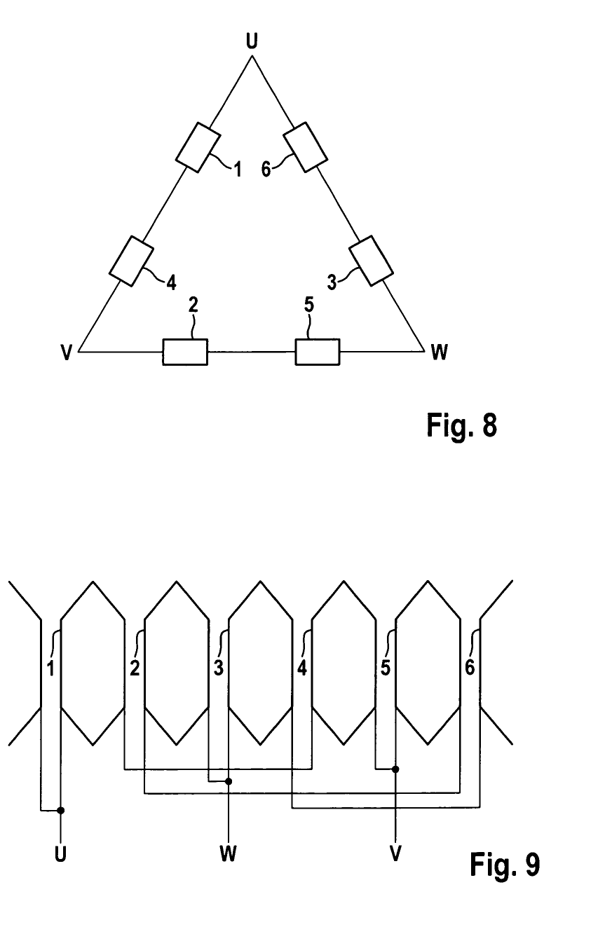

FIGS. 8 to 11 show, in the presentation mode usual in electrical engineering, various ways in which the coils can be interconnected in FIG. 1.

FIG. 1 shows a star-configured circuit as a series circuit.

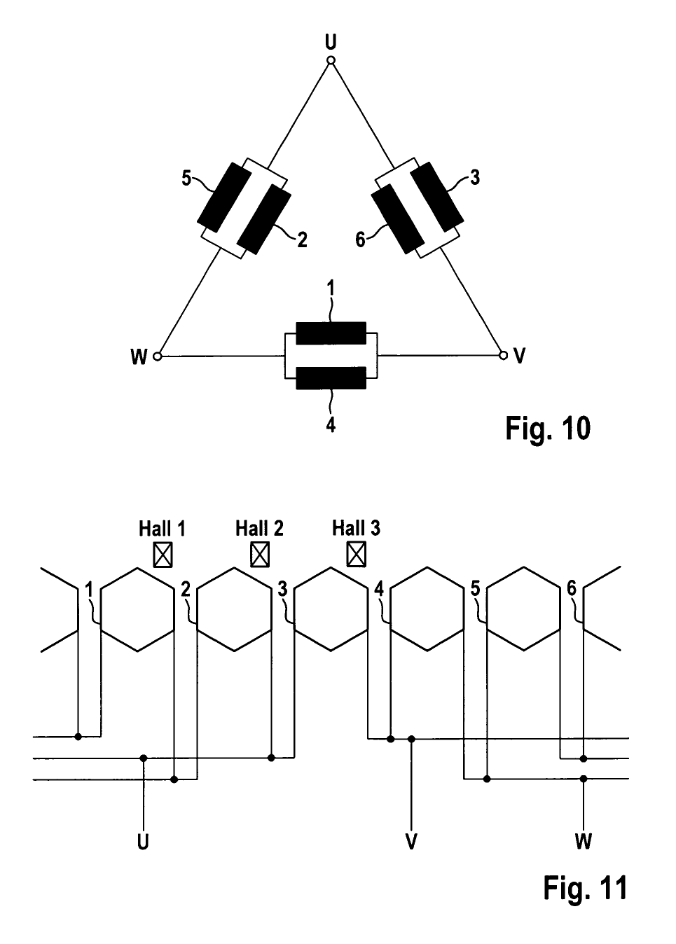

A star-configured circuit as a parallel circuit is also possible. As further examples, FIGS. 8 and 9 show a series delta circuit, and FIGS. 10 and 11 show a parallel delta circuit.

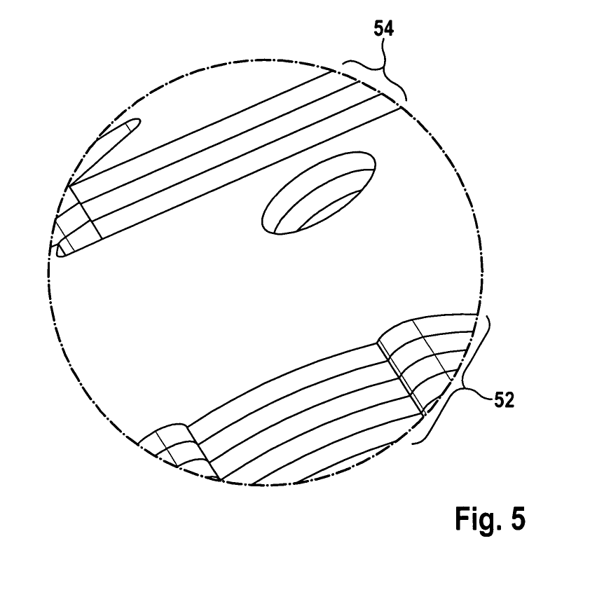

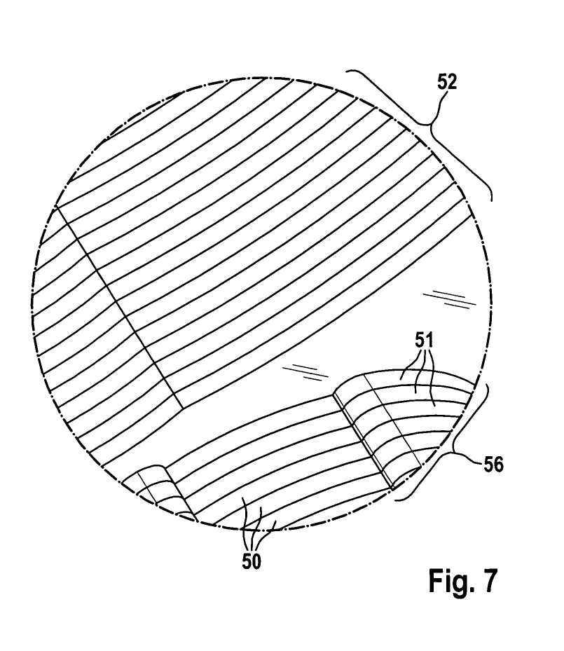

FIGS. 1 to 11 show an internal rotor motor, in particular an electronically commutated internal rotor motor, that comprises: a multi-pole stator 28, a rotor lamination stack 37; 52, 54, 56 mounted rotatably relative to said stator, a central opening 47 provided in the rotor lamination stack, the rotor lamination stack comprising individual laminations 41 whose central openings 47 comprise radially inner first portions 50 into which a shaft 18 is press-fitted, and said central openings 47 comprise, in the sector regions between the radially inner first portions 50, second portions 51 that, in the assembled state, are spaced radially away from the outer side of shaft 18, at least some of individual laminations 41 of rotor lamination stack 52 being arranged with a circumferential angular offset from one another.

Preferably, at least some of the individual laminations 41 of rotor lamination stack 52 are arranged overlappingly relative to one another.

Preferably, at least one end 52A, 52B of the rotor lamination stack, a predetermined number of individual laminations 41 are not arranged with an angular offset from one another, the predetermined number preferably being in the range from 2 to 10.

Preferably openings or pockets 39A, 39B are provided in rotor lamination stack 52, 54, 56, which openings are configured for receiving permanent magnets 38A, 38B, more preferably the angular position of the radially inner first portions with respect to the angular position of openings 39A, 39B, . . . for receiving the embedded permanent magnets 38A, 38B being selected so that axially continuous openings 39A, 39B for receiving permanent magnets 38A, 38B, . . . are produced in rotor lamination stack 52, 52A, 52B.

Preferably an individual lamination 41 of rotor lamination stack 52 is offset, relative to an individual lamination 41 adjacent to it, by an angle that is equal to n*τₚ, where n=1, 2, 3, . . . and τₚ=pole pitch of the rotor poles.

Preferably first portions 50 have respective angular extents which are substantially identical to each other.

Preferably, inwardly projecting first portions 50 have a smaller angular extent than second portions 51.

Preferably a first portion 50 and the adjacent second portion 51 together extend over an angular range of 120° (mechanical), as shown in FIG. 3.

Preferably individual laminations 41 of rotor lamination stack 37; 52, 54, 56 are configured with uniform shapes.

Many variants and modifications are, of course, possible in the context of the present invention.

1. An internal rotor motor, comprising:
a multi-pole stator (28);
a rotor lamination stack (37; 52, 54, 56), mounted for rotation relative to said stator, said stack consisting of a plurality of generally annular individual plates or laminations, each having a respective central opening (47), said respective central openings aligning to define a central bore in the rotor lamination stack, adapted to receive a rotor shaft (18);
wherein inner peripheries of said individual laminations (41) are defined by radially inwardly projecting first portions or tabs (50) into which said rotor shaft (18) is axially press-fitted, and, in angular sectors between the radially inwardly projecting first portions (50), second portions (51) that, after press-fitting of said rotor shaft within said rotor lamination stack (37; 52, 54, 56), are spaced radially away from the outside of the shaft (18), and
wherein at least some (52) of the individual laminations (41) of the rotor lamination stack are arranged with a circumferential angular offset from an adjacent individual lamination.

2. The motor according to claim 1, in which at least some of the individual laminations (41) of the rotor lamination stack (52) are arranged overlappingly relative to one another.

3. The motor according to claim 1, wherein at least one end (52A, 52B) of the rotor lamination stack, a predetermined number of individual laminations (41) are not arranged with said circumferential angular offset from one another.

4. The motor according to claim 3, in which the predetermined number of individual laminations is in the range from 2 to 10.

5. The motor according to claim 1, wherein openings or pockets (39A, 39B) are provided in the rotor lamination stack (52, 54, 56), which openings are configured to receive and thereby embed permanent magnets (38A, 38B).

6. The motor according to claim 5, in which the angular position of the radially inwardly projecting first portions (50) with respect to the angular position of the openings (39A, 39B, . . . ) for receiving the embedded permanent magnets (38A, 38B) is so selected that axially continuous openings (39A, 39B) for receiving the permanent magnets (38A, 38B, . . . ) are defined in the rotor lamination stack (52, 52A, 52B).

7. The motor according to claim 1, wherein an individual lamination (41) of the rotor lamination stack (52) is offset, relative to an individual lamination (41) adjacent to it, by an angle that is equal to n*τₚ, where
n=1, 2, 3, . . .
and τₚ=pole pitch of the rotor poles.

8. The motor according to claim 1, wherein the first portions (50) of respective individual laminations have a substantially identical angular extent.

9. The motor according to claim 1, wherein the respective inwardly projecting first portions (50) each have a smaller angular extent than the second portions (51) spaced from the rotor shaft.

10. The motor according to claim 1, wherein each first portion (50) of a lamination stack inner periphery and the adjacent second portion (51) together extend over a circumferential angular range of 120° (mechanical).

11. The motor according to claim 1, wherein the individual laminations (41) of the rotor lamination stack have respective shapes and thicknesses which are uniform with respect to each other.

12. The motor according to claim 1, wherein
an inside diameter of the central bore, which inside diameter is defined by the first portions (50), is sufficiently smaller than an outside diameter of the rotor shaft (18) that nondestructive press-fitting of the shaft (18) into said rotor lamination stack is possible only if the temperature of the shaft (18), when press-fitting occurs, is lower than the temperature of the rotor lamination stack.
